(19) United States
(12) Patent Application Publication
(10) Pub. No.: US 2026/0242125 A1
(43) Pub. Date: Aug. 20, 2026

(54) CAPSULE FOR THE PREPARATION OF A BEVERAGE

(71) Applicant: SOCIÉTÉ DES PRODUITS NESTLÉ S.A., Vevey (CH)

(72) Inventors: Gilles GERBER, Penthaz (CH); Chiara PAVAN, Vullierens (CH)

(21) Appl. No.: 19/161,467

(22) PCT Filed: Mar. 15, 2024
(86) PCT No.: PCT/EP2024/056911

§ 371 Date: Sep. 2, 2025

(30) Foreign Application Priority Data
Mar. 20, 2023 (EP) 23162805.8

(51) Int. Cl. B65D 85/804; B65D 65/46

(52) U.S. Cl. CPC B65D 85/8064; B65D 65/466; B65D 2565/381

(57) ABSTRACT

A capsule for the preparation of a beverage in a beverage preparation machine is disclosed. The capsule comprises a cup-shaped body and a closing membrane for closing the cup-shaped body. The cup-shaped body comprises an annular flange for the closing membrane to seal thereon. At least the cup-shaped body is made of cellulose pulp and comprises: a bottom wall, a tubular lateral wall and the annular flange. The annular flange further comprises a portion having a surface roughness comprised between 27 and 32 microns. This flange portion having specific roughness characteristics cooperates with an edge of a capsule enclosing member of the beverage preparation machine for improving leak tightness during the preparation of the beverage.

### FIELD OF THE INVENTION

The present invention concerns a capsule for the preparation of a beverage and/or foodstuff in a beverage preparation machine. The capsule comprises a cup-shaped body made of cellulose pulp and is biodegradable, preferably compostable.

### BACKGROUND OF THE INVENTION

Containers or capsules made of cellulose pulp are known in the field of beverage preparation devices and machines. Materials made of cellulose pulp are also known which can maintain the qualities of the beverage substance in the capsule, at least for a certain period of time. Single-use capsules for preparing a beverage in a beverage production device are also known.

These single-use capsules made of cellulose pulp provide a potential reduced environmental impact compared to capsules made of other materials.

Known cellulose pulp made capsules are used in beverage preparation devices and comprise a member enclosing the capsule during the beverage preparation process and the injection of water in the capsule for the preparation of the beverage.

It is essential that the engagement between the capsule and the enclosing member of the capsule cage is tight to prevent water injected into the capsule from flowing outside of the capsule body.

In the event that the sealing engagement between the capsule and the enclosing member of the capsule cage is not good, the water flows outside the capsule without encountering a sufficient resistance to the flow, the pressure necessary to cause tearing of capsule closing membrane will not be built up inside the capsule or, alternatively, the low pressure will cause an incomplete tearing of the closing membrane and therefore a poor extraction of the beverage substance contained in the capsule. In such a scenario water will be drained from the beverage production device without having interacted or completely interacted with the beverage substance under sufficient pressure conditions.

The present invention aims at an improvement of the leak-tightness features of the known cellulose pulp made capsule for the preparation of a beverage in a beverage preparation device.

### SUMMARY OF THE INVENTION

As used herein, the term “machine” or “device” may refer to an electrically operated device or machine that: can prepare, from a precursor material or ingredient, a beverage and/or foodstuff, or; can prepare, from a pre-precursor material, a precursor material that can be subsequently prepared into a beverage and/or foodstuff. The machine may implement said preparation by one or more of the following processes: dilution; heating; pressurisation; cooling; mixing; whisking; dissolution; soaking; steeping; extraction; conditioning; infusion; grinding, and other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” or “capsule” may refer to any configuration to contain the precursor material, e.g. as a single-serving, pre-portioned amount. The container may have a maximum capacity such that it can only contain a single serving of precursor material. The container may be single use, e.g. it is physically altered after a preparation process, which can include one or more of: perforation to supply fluid; for example a liquid like water, to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical, and other like form. The container may be formed from various materials, such as metal or plastic or wood pulp based a combination thereof. The material may be selected such that it is: food-safe; it can withstand the pressure and/or temperature of a preparation process. The container may be defined as a capsule, wherein a capsule may have an internal volume of 5-100 ml. The capsule includes a coffee capsule, e.g. a Nespresso® capsule (including a Classic, Professional, Vertuo, Dolce Gusto or other capsule).

As used herein, the term “system” or “beverage or foodstuff preparation system” may refer to the combination of any two or more of: the beverage or foodstuff preparation machine; the container; the server system, and the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and other extractable substance. As used herein, the term “foodstuff” may refer to any substance capable of being processed to a nutriment for eating, which may be chilled or hot. The foodstuff may be one or more of: a solid; a liquid; a gel; a paste. The foodstuff may include yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and other. Examples of a beverage forming precursor material include ground coffee; milk powder; tea leaves; coco powder; vitamin composition; herbs, e.g. for forming a herbal/infusion tea; a flavouring, and; other like material. Examples of a foodstuff forming precursor material include dried vegetables or stock as anhydrous soup powder; powdered milk; flour-based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of a liquid, for example, water; milk; other.

As used herein the term “wood pulp-based” may refer to the material or a portion of material forming the container which is one or more of: porous; fibrous; cellulosic; formed of cellulosic material; formed of natural cellulosic material; formed of reconstituted or regenerated cellulosic material; non-woven; is composed entirely of or is a composition of wood pulp, and is wet formed. A thickness of the wood-based material may be 0.25 mm to 0.75 mm or about 0.5 mm. The wood-based material may be 200-400 gsm.

As used herein the term “non-woven” may refer to a fabric-like material which is not woven or knitted. A non-woven material may be made from bonded together fibres. As used herein the term “porous” may refer to material configured with interstices to transmit water (or other liquid) therethrough. As used herein the term “fibrous” may refer to material comprised of fibres, which may be present in one or more of the material constituents. As used herein the term “cellulosic” or “cellulosic material” may refer to conventionally woody and/or non-woody materials, e. g. manila hemp, sisal, jute, bleached and unbleached soft wood and hard wood species. A cellulosic material may include a regenerated or reconstituted cellulose. As used herein the term “natural cellulosic material” may refer to conventionally woody materials, which are not regenerated. As used herein the term “reconstituted or regenerated cellulosic material” may refer natural cellulosic material subject to processing that comprises reconstitution or regeneration, examples include rayon and lyocell. As used herein the term “wood pulp” may refer to a lignocellulosic fibrous material, which may be prepared by mechanical or chemical separation of cellulose fibres from one or more of wood, fibre crops, paper or rags. As used herein the term “wet formed” may refer to a process of forming from an aqueous solution of fibres. The aqueous solution of fibres may be heated and pressed in a mould to set the material and remove water therefrom.

The capsule of the invention has a diameter of 2-5 cm and an axial length of 2-4 cm. Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

In variant embodiments, which are not illustrated: the capsule may have other cross-section shapes, including square, other polygons, or elliptical; the closing member may be rigid or other non-membrane formation; the flange is alternatively connected to the upper surface of the closing member, e.g. by crimping; the sidewall is alternatively arranged, including with the reverse taper or is aligned to the depth direction, or is curved; the base is alternatively arranged, including with as flat or curved; the flange portion is connected to the storage portion rather than being integrally formed; the closing member is arranged as a storage portion, e.g. it comprises a cavity, and; the flange portion is omitted, e.g. the closing member connects directly to the storage portion.

The invention as claimed in claim 1 is related to a capsule for the preparation of a beverage in a beverage preparation machine. The capsule comprises a cup-shaped body made of cellulose pulp and a closing membrane for closing the cup-shaped body.

The cup-shaped body and the closing membrane defines a closed cavity for holding a beverage or foodstuff ingredient.

The cup-shaped body comprises an annular flange with a rim portion for the closing membrane to seal thereon. The annular flange also ensures an alignment in the capsule cage/brewing unit.

According to the invention, at least a portion of the annular flange has a surface roughness of the cellulose pulp comprised between 27 and 33 microns.

Advantageously, this protruding part cooperates with an edge of a capsule enclosing member of the beverage preparation machine for improving leak tightness during the preparation of the beverage.

The roughness of a surface is measured as below according to related norm ISO 3274.

Surface roughness, often shortened to roughness, is a component of surface texture. It is quantified by the deviations in the direction of the normal vector of a real surface from its ideal form.

Roughness measurement may use surface profile measurement using a profilometer. In the present case it is done using a contact or stylus profilometers (such as Smithers' portable Handysurf E-35B) which moves a loaded diamond probe across the surface and record the vertical movement of the stylus caused by the surface irregularities.

It is to be noted that the portion of the annular flange comprising the specific surface roughness extends from the lateral wall of the cup-shaped body, on the annular flange, and is integral with both the lateral wall and the annular flange of the capsule. In the present case, there is no additional element/part glued or sealed onto the annular flange which simplifies the production of the capsule.

At least the cup-shaped body is made of cellulose pulp and comprises a bottom wall, a tubular lateral wall, and the annular flange

Preferably, the cup-shaped body is made of cellulose pulp comprising cellulose fibres in a percentage of at least 50% by weight, preferably ranging from 80% to 100% by weight.

In the context of the invention, the term “cellulose pulp” refers to a pulp comprising cellulose fibres in a percentage of at least 50% by weight, preferably ranging from 80% to 100% by weight.

The term “cellulose fibres” refers to fibres having a wood and/or a wood free origin. The fibres, by way of non-limiting examples, are: hard wood cellulose fibres, soft wood cellulose fibres, wheat fibres, corn fibres, bagasse fibres, bamboo fibres, hemp fibres, cotton fibres, other similar vegetable or plant fibres, or a combination thereof.

The cup shaped body of the capsule is preferably obtained by moulding in a mould a dry or wet, preferably wet, cellulose pulp.

The portion of the annular flange with controlled surface roughness extends on the annular flange from the side wall 5, over a radial distance (d) comprised between 0.2 to 5 mm, preferably between 0.5 and 3 mm. The proposed radial extension ensures that the edge of a capsule enclosing member of the beverage preparation machine will interact with the defined portion of the annular flange during use of the capsule in the beverage preparation machine.

In the proposed solution, the annular flange, preferably the said portion of the annular flange comprises a water permeability of 100% water absorption in less than 5 seconds. This water permeability is limited so that the annular flange does not absorb to much water during the capsule extraction process.

Absorption of water would lead the annular flange to swell and increase volume which could lead the capsule to get struck in the beverage preparation machine.

Additionally, the annular flange of the capsule further comprises an external curved and/or curled extension having reduced roughness when compared to the portion of the annular flange. In the same way, this technical feature prevents the capsule to get stuck inside the beverage preparation machine.

In a preferred embodiment of the invention, the cellulose pulp density of said portion of the annular flange (3) is comprised in a converted value of softness between 40 N/mm and 80 N/mm.

In particular, the portion of the annular flange has a thickness similar to the thickness of the annular flange (3), preferably ranging from 0.25 mm to 1 mm, more preferably between 0.3 mm and 0.75 mm, even more preferably about 0.5 mm. This specific characteristic ensures that the capsules does not tilt during interaction with the edge of a capsule enclosing member of the beverage preparation machine and participate in improving the tightness between the capsule and the beverage preparation machine.

In more details, the closing membrane is preferably made as a laminate of multiple material layers having different and specific properties. The closing membrane preferably integrate at least one of a filter layer, a carrier layer and a gas and/or moisture barrier layer. It is preferably made of biodegradable and most preferably of compostable materials, so it is itself biodegradable and/or compostable

The closing membrane may be flat, i.e., non-formed in a three-dimensional shape so as to be sealed onto the rim portion of the annular flange of cup shaped body opening, opposite the portion of the annular flange having specific roughness properties, after the capsule is filled with an ingredient, preferably a beverage ingredient.

According to a further embodiment, the capsule further comprises a barrier layer, preferably at least an oxygen barrier liner attached at the inner and/or outer surface of the cup shaped body made of cellulose pulp. Hence, preferably, after the cup shaped body of the capsule is moulded, the “barrier liner” mentioned above is laminated on the inside and/or outside surface of said body.

The at least one oxygen barrier liner is made of one, preferably several layers.

The oxygen barrier liner is made of a known mono or multilayer polymeric liner, comprising preferably for example a polymer of non-fossil origin or a BioSource polymer, and is attached to the inner surface of the cellulose pulp cup shaped body of the capsule.

A preferred multilayer barrier liner comprises a core layer having oxygen and/or moisture barrier properties, surrounded by a sealing layer for sealing said barrier liner to the cellulose pulp material, and preferably a second external sealing layer for sealing a closing membrane, in order to close the capsule after it has been filled with an ingredient.

Preferably, the multilayer barrier liner also has a moisture or water barrier function

Preferably, the barrier to oxygen/moisture or water for both the closing membrane and the cup shaped body is selected to provide a sufficient shelf life depending on the nature of the beverage ingredients. For coffee, for example, the shelf life expected may be of 12 months.

Preferably, the cavity delimited by the capsule body and the closing membrane of the capsule is essentially oxygen-free and the empty space is saturated with an inert gas such as nitrogen, carbon oxide and combinations thereof which also participate in increasing the shelf life of the capsule. Preferably, the capsule has an internal pressure of gas above atmospheric pressure, due to the gas contained in the coffee and emanating in the cavity after sealing, such as carbon oxide and dioxide.

As mentioned, preferably, the cup shaped body, its oxygen barrier liner and/or the closing membrane are made of home compostable materials. The capsules according to the invention are normally meant to be recycled in recycling processes that are organized at official recycling facilities according to national regulations (for instance in paper recycling streams, or in general garbage recycling or treatment streams). However, in case the capsule is placed in nature, in a household compostable waste or in a landfill, said capsules are designed with materials that are naturally ready to be degraded by bacteria and in conditions of temperature and humidity that are naturally present in nature. In this way, it is ensured that such capsules will not stay in nature and will naturally disappear within a short period of time (a few weeks in principle) within the conditions defined by home compostability standards.

More precisely, home compostability is now well defined on a national level and mainly based on international standard EN 13432; therefore, they do not require to be further defined in-depth in the present specification. Materials or products compliant with these standards can be recognized by a conformity mark stating their home compostability. Some examples of home compostability certifications at a national level include, but are not limited to, the following. The certifier TÜV AUSTRIA BELGIUM offers such a home compostability certification scheme, and DIN CERTCO offers a certification for home compostability according to the Australian standard AS 5810. Italy has a national standard for composting at ambient temperature, UNI 11183:2006. In November 2015, the French Standard “NF T 51-800 Plastics-Specifications for plastics suitable for home composting” was introduced. This standard is covered in the DIN CERTCO scheme.

Preferably but not exclusively, the capsule of the invention is a single use coffee capsule.

The invention also relates to a system comprising a capsule as described according to the invention a beverage preparation machine for preparing a beverage and/or foodstuff thereof. The beverage preparation machine of the system comprises:
a capsule holder portion for holding the capsule on the side of the closing membrane (2);
a capsule enclosing member for maintaining the capsule inside the beverage preparation machine, the capsule enclosing member, when enclosing the capsule, comprising an edge interacting with the portion of the annular flange having specific surface roughness characteristics for improving leak tightness during the beverage preparation;
a liquid injection means for feeding liquid in the capsule;
a processing unit for processing the ingredient material of the capsule, the processing unit comprising a penetrator for piercing the bottom wall of the capsule, and;
an electrical circuitry to control the processing unit.

Hence, the beverage preparation machine preferably comprises a capsule holder for receiving and tightly enclosing the capsule, a pressurized liquid supply system for supplying this liquid inside the capsule. Devices and machines of this type are for example those usually used for the extraction of traditional Nespresso® capsules.

According to the invention, the use of a capsule as above described in a beverage preparation machine is also disclosed.

The preparation of the beverage is obtained by mixing of the fluid substance with an ingredient contained in the capsule. Preferably, the ingredients are chosen within the list of roast and ground coffee, compacted or not, soluble powder coffee or leaf tea. Dairy ingredients (e.g., milk or creamer) could also be provided, as well as chocolate, fruit juices, soups, vegetable juices, bouillons, smoothies, purees, coulis, creams, chicory, barley, culinary aid, soup ingredient, infant formula or a combination thereof, in powdered soluble form, liquid concentrated form having various viscosities or in gel form.

Most preferably, the beverage ingredients are roast and ground coffee.

The capsule of the invention may typically interact with a beverage and/or food preparation machine (device), such as by being fed with a diluent, preferably a fluid (e.g., hot, cold or ambient water) in the container; such diluent mixes, or interacts otherwise, with the beverage ingredients. With the expression “mixing of the diluent with the beverage ingredient(s)” it should be intended that all the ingredients contained in the capsule are in a form which is compatible with a generic mixing operation (dissolution, extraction or infusion) with the diluent to obtain the beverage product.

The present invention also proposes a method for preparing a beverage and/or foodstuff thereof from a beverage and/or foodstuff ingredient of a capsule according to the invention in a beverage preparation machine, the method comprising:
Inserting a capsule in a beverage preparation machine comprising a capsule holder portion and a capsule enclosing member, the capsule enclosing member comprising an edge portion interacting in a fluid-tight manner with a portion of the annular flange of the capsule,
penetrating the cellulose pulp bottom wall of the capsule with a penetrator of said machine to provide fluid inlets,
supplying conditioned fluid to the beverage and/or foodstuff ingredient of the capsule via the fluid inlets, and
processing the beverage and/or foodstuff ingredient.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic side view of an embodiment of a capsule according to the present invention.

FIG. 2 is a side cross-sectional view through section lines A-A of the capsule of FIG. 1.

FIG. 3 is a bottom perspective view of the capsule of FIG. 1.

FIG. 4 is a schematic and partial longitudinal sectional view of the capsule of FIG. 1 when it is enclosed in a capsule enclosing member of a beverage preparation machine.

FIG. 4A is a schematic enlarged view of the portion of FIG. 4 indicated by arrow W1.

### DETAILED DESCRIPTION OF THE INVENTION

Before describing several embodiments of the system, it is to be understood that the capsule, system and method of the invention are not limited to the details of construction or process steps set forth in the following description. It will be apparent to those skilled in the art having the benefit of the present disclosure that the capsule, the system and the method of the invention are capable of other embodiments and of being practiced or being carried out in various ways.

The present disclosure may be better understood in view of the following explanations:

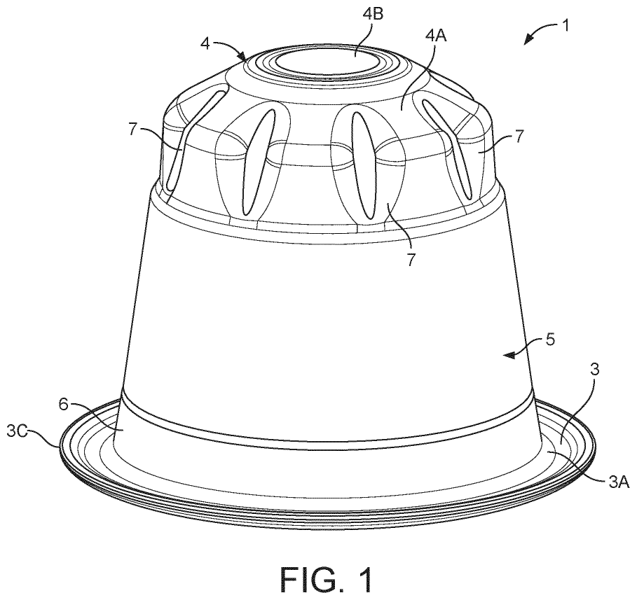

In FIGS. 1, 2 and 3 a proposed embodiment of a capsule according to the invention, for the preparation of a beverage in a beverage preparation machine, is shown. The capsule aims at being inserted inside the beverage preparation machine to be extracted. This capsule comprises a cup-shaped body 1 opening at a first end and a closing membrane 2 for closing the cup-shaped body 1 at the opening location.

The cup-shaped body 1 is made of cellulose pulp and is therefore biodegradable, preferably compostable.

The term “cellulose pulp” refers to a pulp comprising cellulose fibres in a percentage higher than 50% by weight, preferably ranging from 80% to 100% by weight.

The term “cellulose fibres” refers to fibres having a wood and/or a wood free origin. The fibres, by way of non-limiting examples, are: hard wood cellulose fibres, soft wood cellulose fibres, wheat fibres, corn fibres, bagasse fibres, bamboo fibres, hemp fibres, cotton fibres, other similar vegetable or plant fibres, or a combination thereof.

The cup shaped body of the capsule is preferably obtained by moulding in a mould a dry or wet, preferably wet, cellulose pulp.

Alternatively, the cup-shaped body 1 may be shaped from a sheet made of cellulose pulp, by deforming it into a mould to confer to the sheet the desired cup shape, as usual for the skilled person.

The cup-shaped body 1 comprises at least a bottom wall 4 (closing the cup-shaped body at its second end), a tubular lateral wall 5 and an annular flange 3 for the closing membrane 2 to seal thereon.

As can be seen in the Figures, the cup-shaped body 1 is preferably revolutionary symmetrical. Preferably, the tubular wall 5 has a frustoconical shape, with a circular cross section and with an increasing diameter towards the annular flange 3.

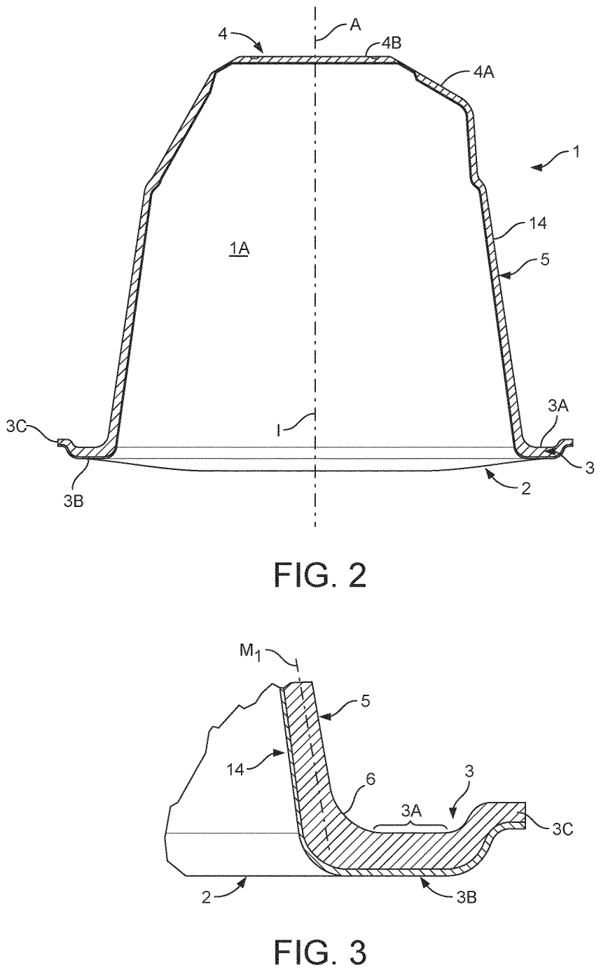

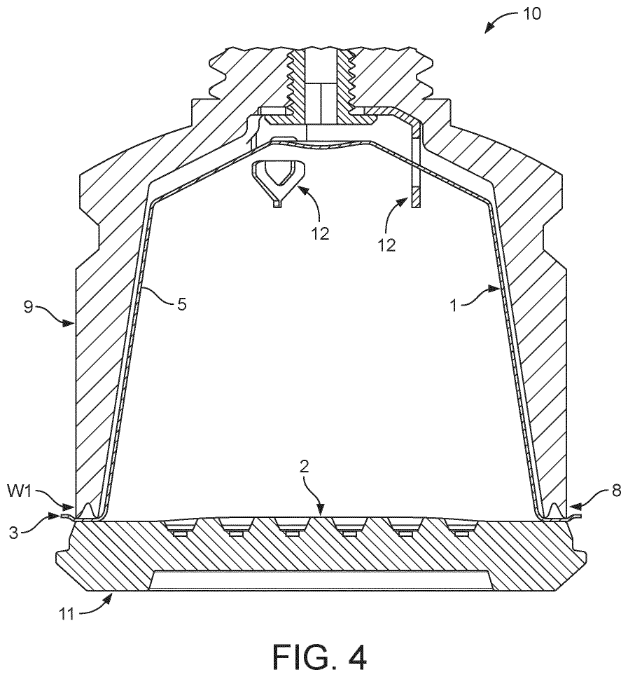

Preferably, the lateral tubular wall 5, when seen in a longitudinal section (shown in FIG. 2), is inclined with respect to a longitudinal axis A of the cup-shaped body 1, in a first inclination direction M1 (shown in FIG. 3).

The bottom wall 4 preferably comprises a first inclined wall 4A and a second wall 4B, so as to delimit a shallow concave volume. The first inclined wall 4A preferably has a frustoconical shape, with a circular cross section and with an increasing diameter towards the lateral wall 5. The second wall 4B is preferably flat (as shown in FIG. 2) or convex (from the point of view of the cavity 1A, i.e., protruding internally towards the cavity 1A).

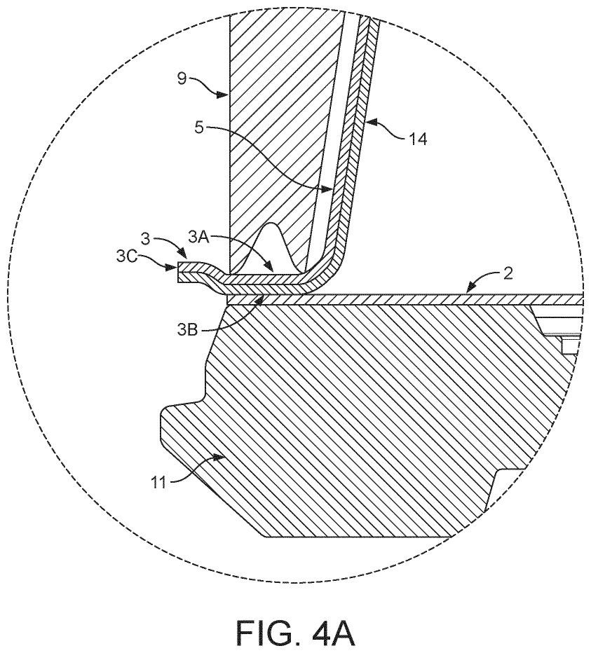

The cup-shaped body 1 also comprises stiffening portions 7, which are disposed between the lateral side wall 5 and the bottom wall 4 to stiffen the cup-shaped body of the capsule. In particular, the stiffening portions 7 aim at stiffening the bottom wall 4 that constitutes a perforation region to be perforated by one or more penetrator element 12 (show in FIG. 4) of the beverage preparation machine.

The annular flange 3 comprises different portions, namely a portion 3A having specific surface characteristics, a rim portion 3B adjoining the opening of the cup-shaped body for the closing membrane 2 to be sealed onto and an external curved and/or curled extension 3C.

The lateral wall 5 and the annular flange 3 are integral and connected by a connecting portion 6 of the cup-shaped body 1. They are therefore made of the same material and are biodegradable, preferably compostable.

The portion 3A of the annular flange 3 comprises a surface roughness of the cellulose pulp material comprised between 27 and 33 microns.

The surface roughness is measured according to ISO 3274

When the capsule is inserted inside the beverage preparation machine 10 (as shown in FIG. 4), the portion 3A cooperating with at least one edge 8 of a capsule enclosing member 9 of the beverage preparation machine. In use, this cooperation, thanks to the specific surface characteristics of the portion 3A of the flange 3 allows improving leak tightness between said enclosing member 9 and the cup-shaped body 1 during the preparation of the beverage during the preparation of the beverage.

This portion 3A is integral with both the lateral wall 5 and said annular flange 3 of the capsule. Hence, portion 3A is also made of cellulose pulp.

It extends on the annular flange 3, from the side wall 5, over a radial distance (d) comprised between 0.2 to 5 mm, preferably between 0.5 and 3 mm.

The below table shows that the tightness between the capsule and the beverage preparation machine obtained with capsules having different surface roughness of the flange.

The tightness is, in the present case, expressed as a quantity of water coming out of the beverage preparation machine between the start of the brewing process and the start of coffee dispensing.

Indeed, the more the tightness is established between the capsule and the beverage machine, the less the quantity of water dispensed before the coffee dispensing is.

| | | Quantity of water before |
|---|---|---|
| Capsule | Roughness of flange | coffee dispensing (start |
| reference | portion (micron) | leakage front weight Max) (g) |
| X1 | 28-32 | 0-0.5 |
| X2 | 24-26 | 19.7 |

As can be seen from the above table, when the roughness of the surface of the flange is below 27 microns the quantity of water leaking from the beverage preparation machine is much higher, at least 35 times higher, than when the roughness of the flange is comprised between 28 and 32 microns.

The controlled roughness of the flange is hence important to avoid leakage between the capsule cage of the beverage machine and the capsule in a pulp molded capsule.

The specific surface roughness of the cellulose pulp of the portion 3A of the annular flange 3 may be obtained using different methods.

For example, in a possible method, different pulp mixing, combining long and short fibres with possible addition of appropriate additives may drive compaction of the fibres with a given surface state.

In another proposed method, texturization during forming of the capsule may lead to obtaining the required localised roughness on the flange. Presently, the moulding tool may comprise a pattern that allows embossing the molded pulp at the flange location.

A post-production texturization may also be envisaged. Mechanical embossing or abrasion as well as laser engraving may be used.

Application or a coating as a post-production step may also be used to modulate the surface roughness

The controlled roughness of the portion 3A of the annular flange allows a better and more gradual interaction between the edge 8 of the movable enclosing member 9 of the beverage preparation machine 10, as well as a better sealing.

In addition to the surface roughness characteristics, the material density of the cellulose pulp of the portion 3A of the annular flange 3 is comprised in a converted value of softness between 40 N/mm and 80 N/mm.

In the context of the invention, the term “density” refers to the “volumetric mass density” of a material, which is the mass per volume unit of this material.

Furthermore, the thickness of the portion 3A of the annular flange is similar to the thickness of the annular flange, preferably ranging from 0.25 mm to 0.75 mm, more preferably about 0.5 mm. There is no local increase in the thickness of the flange or addition of material at this location.

In the proposed capsule, the cup-shaped body 1, preferably the annular flange 3, more preferably the portion 3A comprises a water permeability of 100% water absorption in less than 5 seconds.

The external curved and/or curled extension 3C may have a reduced roughness when compared to the portion 3A of the annular flange 3. Such arrangement may help capsule's ejection from the beverage preparation after extraction of the capsule.

As a conclusion, the shape, the dimensions, the surface roughness and the density of the portion 3A of the annular flange 3 guarantee tightness during the beverage preparation. Tightness is achieved through local interaction, for example by compaction and/or deformation of the cellulose pulp of the portion 3A (as shown in FIG. 4A).

In the course of the preparation of a beverage and/or foodstuff thereof from the beverage and/or foodstuff ingredient of the proposed capsule in the beverage preparation machine,
the capsule is first inserted in the beverage preparation machine which as presented comprises a capsule holder portion 11 and a capsule enclosing member 9, the capsule enclosing member 9 comprising at least an edge portion 8 interacting in a fluid-tight manner with a portion 3A of the annular flange 3 of the capsule,
the cellulose pulp bottom wall 4 of the capsule is then pierced by one or more penetrator element 12 of said machine to provide fluid inlets,
the machine further supplies conditioned fluid, generally water, to the beverage and/or foodstuff ingredient, generally roast and ground coffee, of the capsule via the fluid inlets, and
the beverage and/or foodstuff ingredient is then processed by the beverage machine and extracted to provide the consumer a beverage, generally coffee.

In connection with the drawings, the beverage preparation machine 10, partially disclosed in FIG. 4, comprises the movable enclosing member 9 and the capsule holder in the form of a support plate 11 for supporting the closing membrane 2 of the capsule. In detail, the enclosing member 9 is movable from an initial position (not shown), which allows the introduction of the capsule in the beverage preparation machine, and a brewing position (shown in FIG. 4 and FIG. 4A), wherein the enclosing member 9 and the support plate 11 tightly enclose the capsule. In this configuration, pressurized liquid is injected into the capsule through inlet openings formed by one or more penetrator element 12 of the beverage preparation machine 10. In the present embodiment the three penetrator elements 12 are designed for piercing the bottom wall 4 of the cup-shaped body 1. Upon liquid injection into the capsule and pressure increase inside the capsule, the closing membrane comes into interaction with the support plate 11 which opens the closing membrane and allows the beverage to flow out of the capsule.

The operation of the beverage preparation machine 10, as well as the technical features of its various components, are well known to the skilled person and therefore will not be described in detail.

The closing membrane 2 is made in a known material, preferably it is a polymeric film membrane. The closing membrane 2 is made of at least a home compostable polymer so that it is possible to throw it and more preferably also the cup shaped body in the household compostable waste.

The closing membrane 2 may be flat, i.e., non-formed in a three-dimensional shape.

The closing membrane 2 is not specifically detailed in the Figures however, to ensure an optimised extraction it may be conceived as a laminate comprising at least, a carrier layer, a filter layer and a gas (oxygen for example) and/or moisture barrier layer.

The closing membrane 2 preferably further comprises a sealing layer oriented towards the cavity 1A of the cup-shaped body 1.

As usual, the closing membrane 2 may take a convex form, i.e., protruding externally with respect to the cavity 1A, (as shown in FIG. 2) if the capsule has an internal pressure of gas above atmospheric pressure.

The closing membrane 2 is sealed onto the rim portion 3B of the cup shaped body opening, in order to close the capsule after it is filled with the beverage ingredient.

The cup shaped body made of cellulose pulp comprises a barrier layer, the barrier layer is at least an oxygen barrier liner 14 (FIG. 3) made of at least one, preferably several layers. The barrier layer may also have moisture/water barrier function.

Preferably, after the cup shaped body of the capsule is moulded the oxygen barrier liner 14 is attached in a known manner to the inner surface of the cellulose pulp cup shaped body. However, for example, the oxygen barrier liner 14 is laminated on the inside and/or outside surface of said body.

Preferably the oxygen barrier liner 14 is made of at least a home compostable polymer, so that it is possible to throw the capsule or at least the cup-shaped body in the household compostable waste.

Preferably the multilayer oxygen barrier liner comprises a core layer having oxygen and/or moisture barrier properties, surrounded by a sealing layer for sealing said barrier liner to the cellulose pulp material.

A preferred multilayer barrier liner comprises a core layer having oxygen and/or moisture barrier properties, surrounded by sealing layers for sealing said barrier liner onto the cellulose pulp.

The oxygen barrier liner, by way of non-limiting examples, may comprise one or more of following layers:
an outermost polymeric layer comprising a biodegradable polymer selected within the list of: polybutylene succinate (PBSA/bioPBS), polybutylene adipate terephthalate (PBAT), starch, cellulose derivates, polylactic acid (PLA), polyhydroxyalcanoates (PHA), or a combination thereof,
a first tie layer comprising a biodegradable modified or functionalized polyolefin,
a barrier layer comprising a polymer selected within the list of: butenediol vinyl alcohol copolymer (BVOH), polyvinyl alcohol (PVOH) or a combination thereof,
a second tie layer comprising a biodegradable modified or functionalized polyolefin,
an innermost polymeric layer comprising a biodegradable polymer selected within the list of: polybutylene succinate (PBSA), polybutylene adipate terephthalate (PBAT), starch, cellulose derivates, polylactic acid (PLA), polyhydroxyalcanoates (PHA) or a combination thereof.

Preferably the barrier liner 14 is provided at all the inner surfaces of the cup-shaped body 1, such as to delimit at least the entire cavity 1A for housing the beverage substance.

The oxygen barrier liner 14 is made of a known mono or multilayer polymeric liner, comprising for example a polymer of non-fossil origin or a BioSource polymer, and is attached to the inner surface of the cellulose pulp cup shaped body of the capsule.

Preferably, the first and outermost polymeric layer has a thickness comprised between 10 and 50 μm, and said layer has an elongation at break comprised between 10% and 800%, a melt flow rate (MFR) comprised between 2 and 4 when measured at 150° C. during 10 minutes with a pressure of 2.16 kg, and said layer has a melting point temperature comprised below 80° C.

Preferably, the first tie layer has melting point temperature comprised between 180° C. and 230° C. and a thickness comprised between 1 and 12 μm.

Preferably, the barrier layer has a melting point temperature comprised between 180° C. and 230° C. and a thickness comprised between 1 and 15 μm.

Preferably the second tie layer has a melting point temperature comprised between 180° C. and 230° C. and a thickness comprised between 1 and 10 μm.

Preferably, the innermost polymeric layer has a thickness comprised between 10 and 50 μm, and said innermost layer has an elongation at break comprised between 10% and 1000%, a melt flow rate (MFR) comprised between 4 and 10 when measured at 190° C. during 10 minutes with a pressure of 2.16 kg, and said layer has a melting point temperature comprised between 110° C. and 180° C.

Preferably, the cup shaped body 1 and its oxygen barrier liner 14 are made of home compostable materials (for example in one or more of the materials listed above) so, that it is possible to throw this body it in the household compostable waste.

As an alternative (not represented), the cup-shaped body may comprise a coating integrating an oxygen barrier material.

Preferably, the barrier to oxygen for both the closing membrane and the cup shaped body is selected to provide a sufficient shelf life depending on the nature of the beverage ingredients. For coffee, for example, the shelf life expected may be of 12 months.

As previously mentioned, the complete capsule is biodegradable, most preferably compostable.

In the proposed system, the capsule is interacting with the beverage preparation machine 10.

The beverage preparation machine 10, the machine includes the capsule holder portion 11 for holding the capsule on the side of the closing membrane 2, the capsule enclosing member 9 for maintaining the capsule inside the beverage preparation machine, the capsule enclosing member 9, when enclosing the capsule, comprising the edge 8 interacting with the portion 3A of the annular flange 3 for improving leak tightness during the beverage preparation.

In addition, the beverage preparation machine 10 includes a liquid injection means (not represented) for feeding liquid in the capsule and a processing unit for processing the ingredient material of the capsule, the processing unit comprising one or more penetrator element 12 (as shown in FIG. 4) for piercing the bottom wall 4 of the capsule, and an electrical circuitry to control the processing unit.

With the use of the proposed cellulose-based pulp molded capsule the tight interaction between the beverage preparation machine and the capsule is increased and thereby there is no, or at least reduced, additional liquid (water) falling into the prepared beverage.

It should be understood that various changes and modifications to the presently preferred embodiments of the capsules described herein will be apparent to those skilled in the art. Such changes and modifications can be made without departing from the scope of the present invention covered by the appended claims.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description but is not intended to be exhaustive or to limit the scope of the invention to the precise form disclosed. Modifications and variations are possible in light of the above teachings or may be acquired from practice of various implementations of the present disclosure.

1: A capsule for use with a beverage preparation machine for preparation of a beverage and/or foodstuff, the capsule comprising:
a cup-shaped body and a closing membrane for closing the cup-shaped body, wherein the cup-shaped body and the closing membrane define a closed cavity for holding a beverage and/or foodstuff ingredient,
wherein the cup-shaped body comprises cellulose pulp and comprises a bottom wall, a tubular lateral side wall and an annular flange with a rim portion for the closing membrane to seal thereon, the lateral wall connected to the annular flange,
wherein at least a portion of the annular flange has a surface roughness of the cellulose pulp comprised between 27 and 33 microns,
the portion of the annular flange configured for cooperating with an edge of a capsule enclosing member of the beverage preparation machine for improving leak tightness during the preparation of the beverage and/or foodstuff.

2: The capsule according to claim 1, wherein the portion of the annular flange extends from the tubular lateral side wall, on the annular flange, and is integral with both the tubular lateral side wall and the annular flange of the capsule.

3: The capsule according to claim 1, wherein cellulose pulp of the cup-shaped body comprises cellulose fibres in a percentage of at least 50% by weight.

4: The capsule according to claim 1, wherein the portion extends on the annular flange over a radial distance extending between 0.2 to 5 mm from the tubular lateral side wall.

5: The capsule according to claim 1, wherein the annular flange, preferably the portion of the annular flange comprises a water permeability of 100% water absorption in less than 5 seconds.

6: The capsule according to claim 1, wherein the annular flange further comprises an external curved and/or curled extension having reduced roughness when compared to the portion of the annular flange.

7: The capsule according to claim 1, wherein the cellulose pulp of the portion of the annular flange has a density in a converted value of softness between 40 N/mm and 80 N/mm.

8: The capsule according to claim 1, wherein the portion of the annular flange has a thickness similar to the thickness of the annular flange.

9: The capsule according to claim 1, wherein the closing membrane is biodegradable and/or home compostable and integrates at least one of a filter layer, a carrier layer, and a gas and/or moisture barrier layer, and wherein the closing membrane is connected to the rim portion of the annular flange opposite to the portion configured for cooperating with the edge of the capsule enclosing member of the beverage preparation machine.

10: The capsule according to claim 1, wherein the capsule further comprises at least an oxygen barrier liner attached at an inner surface and/or an outer surface of the cup shaped body, and wherein the oxygen barrier liner is biodegradable and/or home compostable.

11: A system comprising a capsule according to claim 1 and further comprising a beverage preparation machine for preparation of a beverage and/or foodstuff,
the beverage preparation machine including:
a capsule holder portion for holding the capsule on a side of the closing membrane;
a capsule enclosing member for maintaining the capsule inside the beverage preparation machine, the capsule enclosing member, when enclosing the capsule, comprising an edge interacting with the portion of the annular flange for improving leak tightness during the preparation;
a liquid injection means for feeding liquid in the capsule;
a processing unit for processing the beverage and/or foodstuff ingredient of the capsule, the processing unit comprising the one or more penetrator elements for piercing the bottom wall of the capsule; and
an electrical circuitry to control the processing unit.

12. (canceled)

13: A method for preparing a beverage and/or foodstuff from a beverage and/or foodstuff ingredient of a capsule according to claim 1 in a beverage preparation machine, the method comprising:
inserting the capsule in the beverage preparation machine, the beverage preparation machine comprising a capsule holder portion and a capsule enclosing member, the capsule enclosing member comprising an edge portion interacting in a fluid-tight manner with the portion of the annular flange of the capsule,
penetrating the bottom wall of the capsule with one or more penetrator elements of the beverage preparation machine to provide fluid inlets,
supplying conditioned fluid to the beverage and/or foodstuff ingredient of the capsule via the fluid inlets, and
processing the beverage and/or foodstuff ingredient.

14: The capsule according to claim 1, wherein the cellulose pulp of the cup-shaped body comprises cellulose fibres in a percentage of 80% to 100% by weight.

15: The capsule according to claim 1, wherein the portion extends on the annular flange over a radial distance extending between 0.5 and 3 mm from the tubular lateral side wall.

16: The capsule according to claim 1, wherein the portion of the annular flange has a thickness from 0.25 mm to 1 mm.

17: The capsule according to claim 1, wherein the portion of the annular flange has a thickness of about 0.5 mm.
